(19) United States
(12) Patent Application Publication
(10) Pub. No.: US 2006/0271106 A1
(43) Pub. Date: Nov. 30, 2006

(54) Mask assembly with a hidden nipple

(76) Inventor: Chih-I Su, Pingtung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/436,577

(22) Filed: May 19, 2006

(30) Foreign Application Priority Data
May 25, 2005 (TW) 094208508

(51) Int. Cl. A61J 17/00

(52) U.S. Cl. 606/234

(57) ABSTRACT

A mask assembly has a mask having an inner layer cloth and an outer layer cloth combined with the inner layer cloth. A nipple is mounted in the mask and includes a plate and a sucking member. The sucking member is mounted between the inner layer cloth and the outer layer cloth. The sucking member extends out though a hole defined in the inner layer cloth. Accordingly, a baby can wear a mask and a nipple at a same time.

### BACKGROUND OF THE INVENTION

1. Field of the Invention

The present invention relates to a mask assembly with a hidden nipple, and particularly relates to a mask assembly with a hidden nipple mounted on an inner layer cloth, which can be sucked by baby conveniently and secretly.

2. Description of the Related Art

A mask can provide a warming effect to a user's mouth and nose, especially in cold winter. Mask wearing is convenient for adult or juvenile, but not for the baby who is still sucking nipple. In addition, a mask can not be worn on the face of a baby stably when the baby sucks a nipple provided with a loop.

Therefore, the invention provides a mask with a hidden nipple to mitigate or obviate the aforementioned problems.

### SUMMARY OF THE INVENTION

The main objective of the present invention is to provide a mask assembly with a hidden nipple.

The mask assembly has a mask having an inner layer cloth and an outer layer cloth combined with the inner layer cloth. Two suspension loops are mounted at two ends of the mask. A hole is defined through the inner layer cloth. A nipple is mounted in the mask and includes a plate and a sucking member. The plate is mounted between the inner layer cloth and the outer layer cloth. The sucking member is integrally formed on the plate and extends out through the hole in the inner layer cloth.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of the mask assembly with a hidden nipple in accordance with this invention;

FIG. 2 is a top view in partial cross section of the first embodiment of the mask assembly with a hidden nipple in FIG. 1;

FIG. 3 is a perspective view of a second embodiment of the mask assembly with a hidden nipple in accordance with this invention;

FIG. 4 is an exploded view of a third embodiment of a mask assembly with a hidden nipple in accordance with this invention; and

FIG. 5 is a perspective view of the third embodiment of the mask assembly with a hidden nipple in FIG. 4.

### DETAILED DESCRIPTION OF THE PREFERRED EMBODIMENT

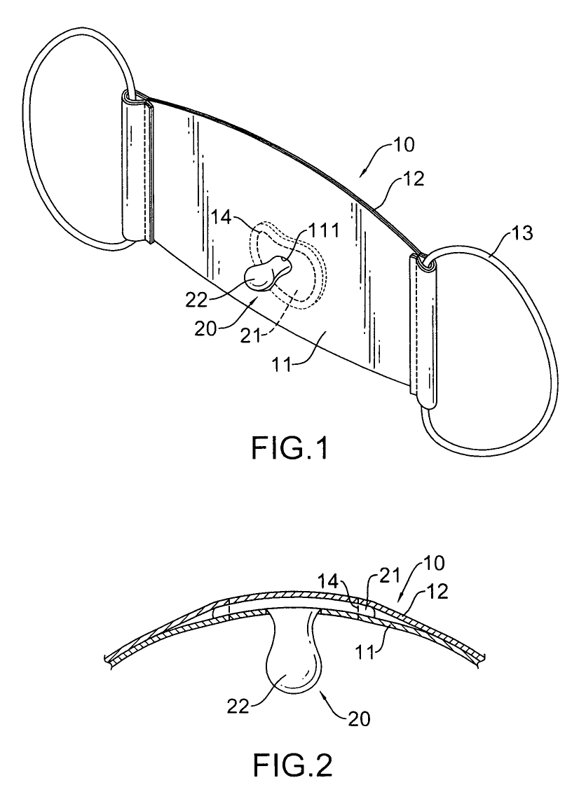

With reference to FIGS. 1-2, a mask assembly in accordance with the present invention comprises a mask (10) having an inner layer cloth (11) and an outer layer cloth (12), and the inner and outer layer cloth (11), (12) are sewn together. Two suspension loops (13) are mounted at two ends of the mask (10) for buckling respectively on ears of a user. A hole (111) is defined through the inner layer cloth (11). A nipple (20) includes a plate (21) and a sucking member (22). The plate (21) is mounted between the inner layer cloth (11) and the outer layer cloth (12). The suck member (22) is integrally formed on the plate (21), and extends through the hole (111) in the inner layer cloth (11) and faces to mouth of a baby.

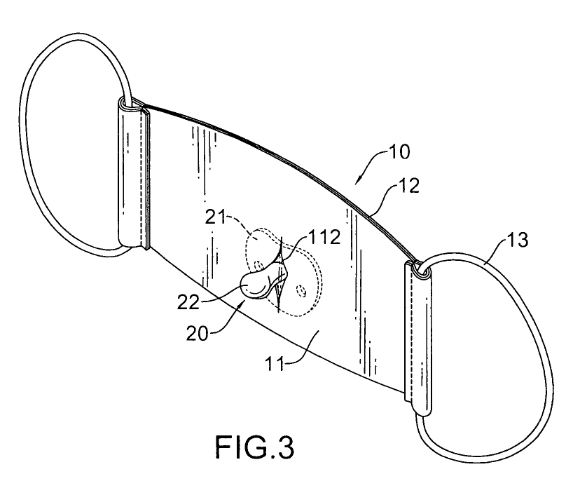

With reference to FIG. 3, a second embodiment of a mask assembly with a nipple in accordance with this invention has a structure same as the first embodiment except that the inner layer cloth (11) has a slit (112) defined therein and through which the plate (21) of the nipple (20) is embedded between the inner layer cloth (11) and the outer layer cloth (12). The sucking member (22) extends out of the inner layer cloth (11) and faces to mouth of a baby.

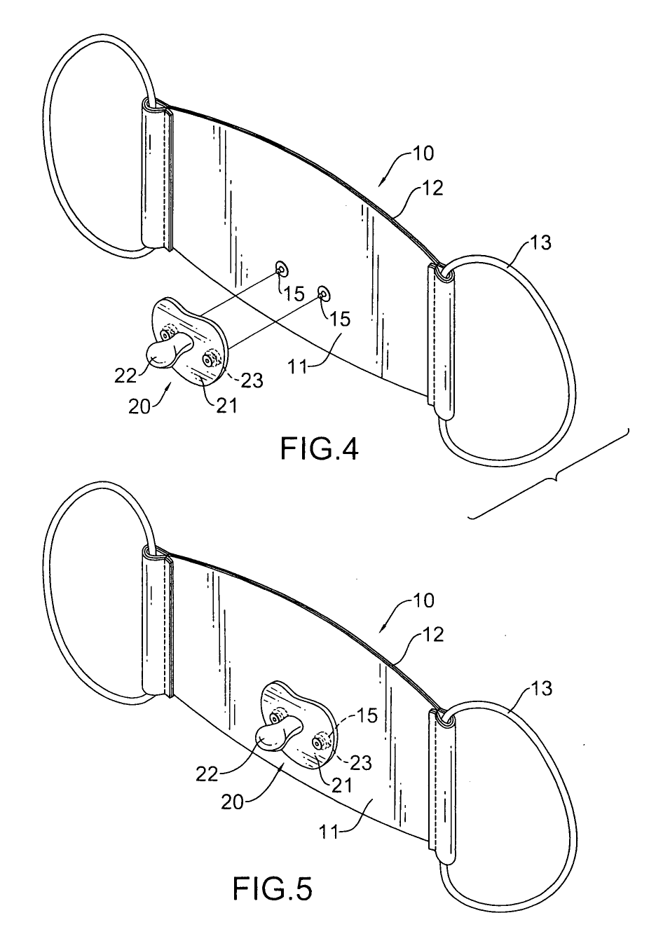

FIG. 4 and FIG. 5 show a third embodiment of a mask assembly with a nipple in accordance with this invention. In the third embodiment, multiple male buttons (15) are mounted in the inner layer cloth (11), and the plate (21) of the nipple (20) has multiple female buttons (23) corresponding respectively to the male buttons (15). Each male button (15) is engaged with a corresponding female button (23), and thus the nipple (20) is detachably attached to the inner layer cloth (11).

The mask assembly in accordance with this invention has a nipple (20) mounted on the inner layer cloth (11). Accordingly, the nipple (20) is hidden when a baby wears the mask on, so the baby a wears a mask (10) and a nipple (20) at a same time.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A mask assembly comprising a mask and a nipple mounted in the mask.

2. The mask assembly as claimed in claim 1, wherein
the mask has
an inner layer cloth,
an outer layer cloth combined with the inner layer cloth,
two suspension loops mounted respectively at two ends of the mask, and
a hole defined through the inner layer cloth;
the nipple includes
a plate mounted between the inner layer cloth and the outer layer cloth; and
a sucking member integrally formed on the plate and extending out from the hole in the inner layer cloth.

3. The mask with a nipple as claimed in claim 1, wherein
the mask has
an inner layer cloth,
an outer layer cloth combined with the inner layer cloth,
two suspension loops mounted respectively at two ends of the mask, and
a slit defined through the inner layer cloth;
the nipple includes
a plate mounted between the inner layer cloth and the outer layer cloth through the slit; and
a sucking member integrally formed on the plate and extending out from the slit in the inner layer cloth.

4. The mask with a nipple as claimed in claim 1, wherein
the mask has
an inner layer cloth,
an outer layer cloth combined with the inner layer cloth,
two suspension loops mounted respectively at two ends of the mask, and
multiple male buttons mounted on the inner layer cloth;
the nipple includes
a plate mounted between the inner layer cloth and the outer layer cloth;
multiple female buttons mounted on the plate and respectively corresponding to and engaging with the male button on the inner layer cloth; and
a sucking member integrally formed on the plate and extending out from the hole in the inner layer cloth.
